(19) United States
(12) Patent Application Publication
(10) Pub. No.: US 2012/0209970 A1
(43) Pub. Date: Aug. 16, 2012

(54) SYSTEMS AND METHODS FOR FACILITATING USER CONFIDENCE OVER A NETWORK

(75) Inventors: German Scipioni, San Jose, CA (US); Jason Korosec, San Jose, CA (US)

(73) Assignee: EBAY INC., San Jose, CA (US)

(21) Appl. No.: 13/028,014

(22) Filed: Feb. 15, 2011

(51) Int. Cl. G06F 15/173

(52) U.S. Cl. 709/223

(57) ABSTRACT

A system and method for facilitating user confidence over a network, according to one or more embodiments, includes receiving an inquiry from a user via a user device over the network, obtaining information related to the user from the inquiry, accessing a user account related to the user based on information passed with the inquiry, reviewing user transaction history of one or more previous transactions conducted over the network between the user and one or more other users, reviewing user connections of one or more other users that have prior knowledge of the user, determining a universal trust score based on user information related to the user transaction history and the user connections, and notifying the user of the universal trust score via the user device over the network.

### BACKGROUND

1. Technical Field

The present invention generally relates to facilitating electronic commerce over a network and, more particularly, to facilitating user confidence over a network.

2. Related Art

In some online financial transactions, users may search for and purchase products and services from other users through electronic communications with online merchants over electronic networks, such as the Internet. In some electronic commerce environments, a user may interact with some other unknown user. In these situations, trust between multiple users is mutually beneficial prior to conducting financial transactions.

However, there are some situations where unknown users have no way to remotely establish trust or confidence prior to conducting online transactions. In an anonymous type of online marketplace, buyers and sellers may be faced with uncertainty or lack of trust with the other. For example, after listing items for sale, sellers may receive many responses from potential buyers, but in some instances, the seller may need to determine which buyers are safe and/or trustworthy to conduct business including granting permission to a potential buyer to meet for exchange or accepting payment prior to delivery.

When conducting online transactions, such as purchase and information exchanges, establishing trust between users may be difficult and uncertain. As such, there exists a need to improve user confidence over a network.

### SUMMARY

Embodiments of the present disclosure provide a systems and method for facilitating electronic commerce including facilitating user confidence over a network. The system and method include receiving an inquiry from a user via a user device over the network, obtaining information related to a target user from the inquiry, accessing a user account related to the target user based on information passed with the inquiry, reviewing user transaction history of one or more previous transactions conducted over the network between the target user and one or more other users, reviewing user connections of one or more other users that have prior knowledge of the target user, determining a trust score based on user information related to the user transaction history and the user connections, and notifying the user of the trust score via the user device over the network. The target user can be the user or another person with which the user is inquiring about, such as whether to move forward with a transaction. As such, user may be either a target user or the actual user.

In various implementations, the method may include communicating with a plurality of users via a plurality of user devices over the network, prompting the user to login over the network after receiving the inquiry from the user via the user device over the network, receiving user information including user identity information from the user via the user device over the network, verifying the identity of the user based on the user information, verifying the user account related to the user based on the verified identify of the user, and storing the universal trust score in a memory component of the server as part of the user account related to the user.

In various implementations, the method may include reviewing user identity information including verifying an email address of the user stored as part of the user account. The universal trust score may be determined based on user identity information including the verified email address of the user. In one aspect, reviewing user identity information may include determining if the user belongs to an online marketplace with an established global network of known users, and purchasing and spending patterns of these known users may be utilized to identify a degree of trustworthiness of the user. User transaction history may include information related to the user stored as part of the user account, and user transaction history may include a value or number associated with a rating of the user. In another aspect, reviewing user transaction history may include reviewing credit card transaction history related to the user, and submission of a credit card number by the user may provide a secure promise for payment. In another aspect, reviewing user transaction history may include reviewing customer feedback scores and comments related to the user that indicates a degree of trustworthiness of the user.

In various implementations, user connections may include information related to the user stored as part of the user account, and user connections may include a value or number associated with a rating of the user. In one aspect, reviewing user connections may include reviewing information from online navigation sites to confirm that an email address of the user is positively connected to a name of the user and/or a residential address of the user. In another aspect, reviewing user connections may include accessing social network sites to identify and determine a degree of trust that the user is connected to other users.

In various implementations, the universal trust score comprises a combination of an absolute number based on user transactional history and a relative number based on user connections with other users. The universal trust score provides a degree of trust via one or more of confirmed identity information, confirmed email address, confirmed purchasing history, confirmed selling history, confirmed delivery addresses, and confirmed payment reconciliation. In one aspect, notifying the user of the universal trust score may include notifying the user via an email message, a text message, an instant message, and/or a voice message over the network. In another aspect, the method is performed by a network server adapted to communicate with the user device over the network.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 shows a block diagram of a system adapted to facilitate electronic commerce including facilitating user confidence over a network, in accordance with embodiments of the present disclosure.

FIG. 2 shows a block diagram of a method adapted to facilitate electronic commerce including facilitating user confidence over a network, in accordance with embodiments of the present disclosure.

FIG. 3 shows a block diagram of a computer system suitable for implementing one or more embodiments of the present disclosure.

Embodiments of the invention and their advantages are best understood by referring to the detailed description that follows.

### DETAILED DESCRIPTION

Embodiments of the present disclosure provide systems and methods for facilitating electronic commerce including user confidence over a network. In various implementations, user confidence refers to a process of identifying, determining, and/or calculating a universal trust score for users, including buyers, sellers, merchants, etc. In some electronic commerce (i.e., e-Commerce) environments, a user may interact with another unknown user. In these situations, trust between multiple users is mutually beneficial prior to conducting financial transactions. For example, a credit card may provide trust between a user and a merchant, wherein submission of a credit card by the user provides a secure promise for payment to the merchant. In another example, an online marketplace (e.g., eBay) may provide a feedback score for buyers and sellers that reliably indicates a trustworthiness of the respective buyers and sellers. In still another example, some large sellers or merchants, such as Best Buy or Amazon, provide a purchase guarantee that the purchased product is correct and in working condition, or the buyer receives a monetary refund for the purchase.

However, there are some situations where there are two unknown users or parties and no way to remotely establish trust or confidence. For example, in an anonymous type online marketplace (e.g., Craigslist), both buyers and sellers may be faced with uncertainty or a lack of trust in the other party. After listing products for sale, sellers may receive many responses from potential buyers, but in this instance, the seller may need to determine which buyers are safe and/or trustworthy to conduct business including, for example, granting permission to a potential buyer to meet for exchange. In another example, buyers may need to be wary of a seller if a purchase exchange is agreed upon, wherein the buyer is committed to meet with the seller at a particular destination with monetary funds in hand. In either example, the anonymous type online marketplace provides the buyer and/or seller with little knowledge of the other, such as only an email address and maybe a name of the person responding to the ad. In this instance, only the email address may be verified.

Embodiments of the present disclosure provide systems and methods for facilitating user confidence over a network by providing a universal trust score for users, buyers, sellers, merchants, etc. that may be considered “trustworthy” in financial transactions. For example, embodiments of an online marketplace or service provider, such as eBay and/or PayPal, have established a large global network of known users, buyers, sellers, merchants, etc. and utilize purchasing and spending patterns of these known users, buyers, sellers, merchants, etc. to identify a degree and/or value of trustworthiness and/or confidence. In another example, a universal trust score may comprise a combination of an absolute number based on a buyer's transactional history and a relative number based on how many and/or how strong a connection is between the buyer and seller. In still another example, a universal trust score may be developed as a user identifier or look-up tool on an online website, such as a social network site, that may not refer to an established relationship between users, such as becoming an online friend with another user (i.e., friending another user). A user may also be friends or connected with others who are known fraudsters.

Embodiments of the present disclosure provide systems and methods for providing a certain degree of trust via confirmed identity information of known users, buyers, sellers, merchants, etc., such as confirmed email addresses, confirmed purchasing history, confirmed selling history, confirmed delivery addresses, confirmed payment reconciliation, etc. In one aspect, confirming online identity may be considered a challenge in network based financial transactions from a corporate perspective to prevent fraud and a user's perspective when interacting with another unknown user in an online setting, such as classified ads. In another aspect, recommendations and comments posted may suffer from a lack of credibility due to the unknown factor of another user's identity. For example, comments, users, and/or content from a trusted network site may be highlighted as a way to sift through relevant information to review and separate good information from bad information. A look-up tool may be utilized by a user to search for an email before a purchase is conducted on a network based classified website, such as craigslist. A browser plug-in may be utilized to highlight or bring-up content and/or merchant information from known users in a known network. A recommendation engine may be utilized to show merchants and/or products purchased from known users in a known network. Accordingly, various forms of information from a known online network, such as a trusted social network may be combined with real information about a user's known track record in online purchase transactions.

Embodiments of the present disclosure provide systems and methods for augmenting confirmed identity information with additional sources. The first may be from free sources, such as pulling data from online navigation sites, such as Google and/or Bing, to confirm that an email is not linked to a fraudulent site or confirm that an email is positively connected to a name and/or address (e.g., a user with a particular email address is truly a person living at a confirmed residential address). The second may be from other network sites, such as tapping into social network sites, such as LinkedIn, Facebook, or some other social network site, to identify or determine a degree of trust that the user is truly connected to the other party. In one aspect, a trust or confidence level may increase if it is known that a) a user is truly legitimate, resides locally, and has a real occupation and b) the user is friends with other known users, buyers, sellers, merchants, etc.

In one embodiment, if implemented on an anonymous online marketplace, a user may pay a fee (e.g., $1 to $5) to receive a confirmed email address, or the user may be paid a fee (e.g., $1) for every email address the user verifies. In one implementation, for every buyer that responds to the seller, the service provider for the online marketplace may return a trust code or score to the seller that provides a degree of trust for the buyer. For a particular email address provided by the buyer, the seller may be provided with an “A” for internet transaction, a “B” for matching to the physical location, and an unknown on the network, which may refer to a “good” chance of success with a listing. The seller may provide another email address for another buyer, and the service provider may return an “unknown” for internet transaction, an “A” for physical location, and an “A” for matching to the physical location because the buyer is two nodes removed from the seller in a social network. In another implementation, a similar situation may be similarly applied to the buyer, where the buyer may test the seller before meeting with the seller for a purchase exchange.

Accordingly, users belonging to a service provider network may be linked to known social network sites to assist with authenticating a user's identity and/or determine a level of risk or fraud. In one aspect, social networks may provide information about types of other users associated with a particular user, which may include, for example, direct contacts that are known fraudsters. These and other aspects of the present disclosure are described in greater detail herein.

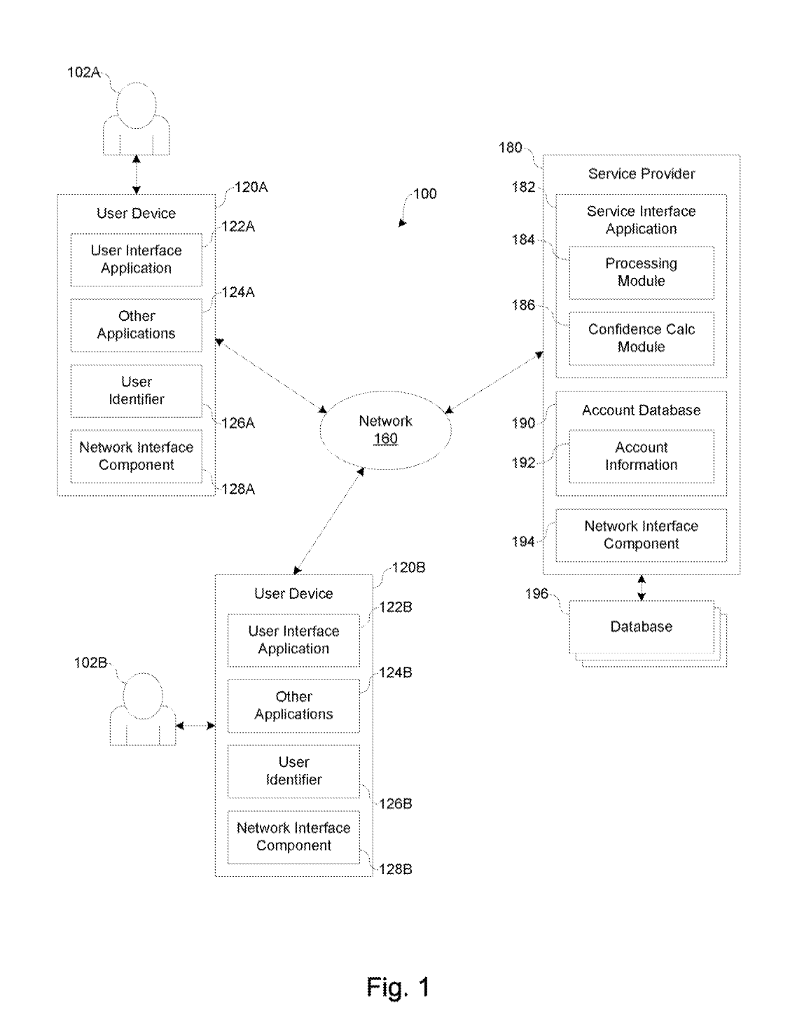

FIG. 1 shows one embodiment of a system 100 adapted for facilitating electronic commerce including user confidence over a network 160, such as the Internet and/or a mobile communication network. As shown in FIG. 1, the system 100 includes one or more user devices 120A, 120B adapted for use by users 102A, 102B, respectively, such as a client, customer, consumer, buyer, seller, merchant, etc.) to interface with each other and a service provider 180 (e.g., a network based transaction service provider, such as a payment processor and/or a user identity verifier) over the network 160. In various implementations, it should be appreciated that one or more of the user devices 120A, 120B may be utilized by users 102A, 102B as a merchant device for business activities including proffering items, products, and/or services for purchase over the network 160.

The network 160, in one embodiment, may be implemented as a single network or a combination of multiple networks. For example, the network 160 may include a wireless telecommunications network (e.g., cellular telephone network) adapted for communication with one or more other communication networks, such as the Internet. In other examples, the network 160 may include the Internet, one or more intranets, landline networks, wireless networks, and/or one or more other appropriate types of communication networks. As such, in various implementations, the user devices 120A, 120B and the service provider 180 may be associated with a particular link (e.g., a link, such as a URL (Uniform Resource Locator) to an IP (Internet Protocol) address).

The user devices 120A, 120B, in various embodiments, may be implemented using any appropriate combination of hardware and/or software configured for wired and/or wireless communication over the network 160. In one embodiment, the user devices 120A, 120B may be implemented as a mobile communication device (e.g., wireless cellular phone) adapted for communication with the network 160. In other embodiments, the user devices 120A, 120B may be implemented as a personal computer (PC), a personal digital assistant (PDA), a notebook computer, and/or various other generally known types of wired and/or wireless computing devices for communication with the network 160. In various aspects, it should be appreciated that the user devices 120A, 120B may be referred to as a client device, customer device, consumer device, buyer device, seller device, merchant device, etc. without departing from the scope of the present disclosure.

The user devices 120A, 120B, in one embodiment, include user interface applications 122A, 122B, which may be utilized by the users 120A, 120B to conduct network based financial transactions (e.g., remote network based electronic commerce) with each other and the service provider 180 over the network 160. In various implementations, user interface applications 122A, 122B may be implemented as electronic commerce applications and/or mobile commerce applications to initiate, track, manage, and store data and information including user confidence data and information related to each other and network based electronic commerce for viewing, searching, and/or purchasing items, products, and/or services over the network 160. In one aspect, the user devices 120A, 120B may be linked to an account with the service provider 180 for direct and/or automatic settlement of purchase requests between users 102A, 102B via the user interface application 122A, 122B.

In one embodiment, the user interface applications 122A, 122B comprises a software program, such as a graphical user interface (GUI), executable by a processor configured to interface and communicate with each other, other user devices, and/or the service provider 180 via the network 160. In one implementation, the user interface applications 122A, 122B comprise a browser module adapted to provide a network interface to browse information (e.g., user confidence information) available over the network 160. For example, the user interface applications 122A, 122B may be implemented, in part, as a web browser to view and search various types of data and information available over the network 160. In another example, the users 102A, 102B are able to access other user websites over the network 160 to view, search, and select items, products, and/or services for purchase, and the users 102A, 102B are able to purchase selected items, products, and/or services from each other and other users via the service provider 180. In another example, the users 102A, 102B are able to access a website of the service provider 180 over the network 160 to access and view their own user accounts including payment media accounts related to each user 102A, 102B, and the users 102A, 102B are able to update their own user accounts and open new accounts including payment media accounts. In still another example, the users 102A, 102B may conduct network based financial transactions with each other and other users via the service provider 180 over the network 160.

In one embodiment, upon user instruction, the user interface applications 122A, 122B may be installed and/or run on the user devices 120A, 120B, respectively. The users 102A, 102B may run the user interface applications 122A, 122B on the user devices 120A, 120B to access the service provider 180 via the network 160. In one aspect, upon installation and/or execution of user interface application 122A, 122B, the users 102A, 102B may be prompted to establish at least one user account for login with the service provider 180, wherein the users 102A, 102B may use the user interface application 122A, 122B and the user devices 120A, 120B to access the service provider 180 via the network 160. When establishing a user account, the users 102A, 102B may be asked to provide personal information, such as name, location information (e.g., address), phone number, etc., and financial information, such as banking information, credit card information, etc. In another aspect, information related to each user 102A, 102B may be packaged as user identifiers 126A, 126B, which is described in greater detail herein.

The user devices 120A, 120B, in various embodiments, may include one or more other applications 124A, 124B as may be desired to provide additional features available to each user 102A, 102B. In various examples, such other applications 124A, 124B may include security applications for implementing user-side security features, programmatic client applications for interfacing with appropriate application programming interfaces (APIs) over the network 160, and/or various other types of generally known programs and/or software applications. In various other examples, other applications 124A, 124B may interface with the user interface applications 122A, 122B for improved efficiency and convenience. In one aspect, files, data, and/or information may be imported from various types of accounting software (e.g., a spreadsheet application) directly into the user interface applications 122A, 122B for improved tracking of payments and settlements related to purchases via the network 160. Accordingly, it should be appreciated that the user interface applications 122A, 122B and each of the other applications 124A, 124B are adapted to make API calls over the network 160.

The user devices 120A, 120B, in various embodiments, may include user identifiers 126A, 126B, which may be implemented as operating system registry entries, cookies associated with the user interface applications 122A, 122B, identifiers associated with hardware of user devices 120A, 120B, and/or various other appropriate identifiers. The user identifiers 126A, 126B may include one or more attributes related to each user 102A, 102B, such as personal information related to each user 102A, 102B (e.g., one or more user names, passwords, photograph images, biometric ids, addresses, phone numbers, etc.) and banking information (e.g., one or more banking institutions, credit card issuers, user account numbers, security data and information, etc.). In various aspects, the user identifiers 124A, 124B may be passed with user transaction requests to the service provider 180 via the network 160, and the user identifiers 126A, 126B may be utilized by the service provider 180 to associate the user with a particular user account maintained by the service provider 180. In still another aspect, the user identifiers 126A, 126B may include a universal trust score related to each user 102A, 102B, such as degree, measure, and/or value associated with a perceived trust and/or confidence related to each user 102A, 102B, respectively. The universal trust score may be earned, purchased, relegated, attached, assigned, and/or some combination thereof, without departing from the scope of the present disclosure.

The user devices 120A, 120B, in one embodiment, may include network interface components (NIC) 128A, 128B adapted for communication with the network 160. In various implementations, the network interface components 128A, 128B may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface components 128A, 128B may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

In one embodiment, the user devices 120A, 120B may be maintained as one or more network servers by one or more business entities (e.g., merchant sites, resource information sites, utility sites, real estate management sites, social networking sites, etc.) offering various items, products, and/or services for purchase and payment, which may need registration of user identity information as part of offering the items, products, and/or services to one or more users over the network 160. As such, the user devices 120A, 120B may comprise at least one network based server in communication with the network 160 having user interface applications 122A, 122B with the addition of a products/services database for presenting and identifying one or more available items, products, and/or services for purchase via the network 160, which may be made available to users over the network 160 for viewing and purchasing by the users. In one implementation, each of the network based merchant servers may be accessible via a mobile communication device (e.g., wireless cellular phone) for management purposes. For example, each merchant entity may remotely access and interact with their own network based merchant server via a mobile communication device for management purposes.

In one embodiment, the user interface applications 122A, 122B may be utilized to conduct network based financial transactions (e.g., remote network commerce, such as shopping, purchasing, bidding, etc.) with other users via other user devices and/or the service provider 180 over the network 160. For example, the user interface applications 122A, 122B may be implemented as an electronic commerce application to initiate, track, manage, and store data and information related to remote network based commerce for viewing, searching, and purchasing of items, products, and/or services over the network 160. In one aspect, each user device 120A, 120B may be linked to an account with the service provider 180 for direct and/or automatic settlement of purchase transactions between users via the user interface applications 122A, 122B.

In one implementation, the user interface applications 122A, 122B may comprise a software program, such as a GUI, executable by a processor configured to interface and communicate with other users via user devices and/or the service provider 180 over the network 160. In another implementation, user interface applications 122A, 122B comprise a network interface module that makes information available to other user devices over the network 160. For example, the user interface applications 122A, 122B may be implemented, in part, as a website manager to provide, list, and present information to other user devices over the network 160. In another example, merchants and sellers are capable of providing network based merchant websites to allow other users to view, search, and select items, products, and/or services for purchase, and the other users are capable of purchasing items, products, and/or services via merchant websites and the service provider 180. As such, each user device 120A, 120B may operate as a merchant device to conduct financial transactions with other users and the service provider 180 over the network 160.

In various implementations, the user interface applications 122A, 122B may include a marketplace application, which may be configured to provide transaction information related to products and/or services made available over the network 160. In one aspect, transaction information may include user confidence information, such as a universal trust score. For example, users may interact with other users via the marketplace application through user interface applications 122A, 122B over the network 160 to search and view various items, products, and/or services available for purchase from a products/services database. In one implementation, the marketplace application may include a checkout module adapted to facilitate online financial transactions with other users, and the checkout module may be adapted to accept payment from other users and process the accepted payment via interaction with the service provider 180.

In one aspect, when a user establishes a merchant account, the user may be asked to provide business information, such as business name, location information (e.g., address), phone number, etc., and financial information, such as banking information, credit card information, taxing entity, etc. In another aspect, information related to the merchant user may be packaged as the user identifier or as a separate merchant identifier.

For example, the user identifier or merchant identifier may be included as part of the one or more items, products, and/or services made available for purchase so that particular items, products, and/or services are associated with particular users. In one implementation, the user identifier or merchant identifier may include attributes and/or parameters related to the user, such as business and/or banking information. For example, the user identifier or merchant identifier may be passed from each particular merchant to the service provider 180 when another user selects an item, product, and/or service for holding, monitoring, and/or purchasing from the selling user. In one aspect, the user identifier or merchant identifier may be used by the service provider 180 to associate particular items, products, and/or services selected for purchase with a particular merchant account maintained by the service provider 180. In another aspect, users may conduct financial transactions (e.g., selection, monitoring, purchasing, and/or providing payment for items, products, and/or services) via the service provider 180 over the network 160.

The service provider 180, in one embodiment, may be maintained by a network based transaction processing entity, which may provide processing, delivery, and settlement for network based transactions including online information and/or financial transactions on behalf of the user via the user devices 120A, 120B. Referring to FIG. 1, the service provider 180 includes a service interface application 182, which may be adapted to interact with the user devices 120A, 120B over the network 160 to facilitate electronic commerce including processing card verification data and information. In various aspects, financial transactions may include the selection, purchase, and/or payment of items, products, and/or services by a user via the user devices 120A, 120B. In some examples, purchase and payment for selected items, products, and/or services between users may include one or more tax assessments. In one embodiment, the service provider 180 may be provided by a network based transaction processing entity, such as PayPal, Inc. and/or eBay of San Jose, Calif., USA.

The service interface application 182, in one embodiment, is adapted to utilize a processing module 184 to process purchases and/or payments, including card verification, for financial transactions between the user devices 120A, 120B. In one implementation, the processing module 184 is adapted to resolve financial transactions through validation, delivery, and settlement. For example, the processing module 184 may be adapted to communicate with a clearing house, such as automated clearing house (ACH), to debit a user account related to a user or buyer according to an amount specific in a payment and credit therewith another user account related to a merchant or seller. In another implementation, the processing module 184 is adapted to assess and disperse taxes for financial transactions through validation, delivery, and settlement. For example, tax assessment may include automatically calculating tax on Internet purchases based on buyer location, seller location, and/or type of items, products, and/or services purchased. Accordingly, the service interface application 182 in conjunction with processing module 184 is adapted to settle indebtedness on behalf of users, wherein accounts may be directly and/or automatically debited and/or credited of monetary funds in a manner as accepted by the banking industry.

The service interface application 182, in one embodiment, is adapted to utilize a confidence calculation module 186 to identify, determine, and/or calculate a universal trust score for users, including buyers, sellers, merchants, etc. In one aspect, when interacting with unknown users, a user may desire to determine a level of trust with the unknown user prior to conducting financial transactions, which is mutually beneficial. For example, a credit card may provide trust between a buyer and a seller, wherein submission of a credit card by the buyer provides a secure promise for payment to the seller. In another example, an online marketplace may provide a feedback score for buyers and sellers alike that reliably indicates a trustworthiness of the respective buyers and sellers. In another example, some sellers or merchants may provide a purchase guarantee that the purchased product is correct and in working condition, or the buyer receives a monetary refund for the purchase.

In one implementation, the confidence calculation module 186 may be utilized to verify payment media (e.g., debit card and/or credit card) on behalf of a user for network based financial transactions. For example, the confidence calculation module 186 may be adapted to enhance user experience by enabling service users to determine a level of trust for financial transactions over the network 160. In another example, a user may communicate with the service provider 180 for utilization of the confidence calculation module 186 as part of a checkout procedure or during payment processing.

The service interface application 182, in one embodiment, may be adapted to utilize a notification module, which is adapted to notify users of their own universal trust score or another user's universal trust score prior to conducting network based financial transactions over the network. In one aspect, the service interface application 182 in combination with the notification module may be adapted to notify or alert users with notifications or alerts (e.g., email message, text message, instant message, voice message, etc.) provided over the network 160. The users 102A, 102B may review one or more universal trust scores via notifications or alerts displayed on user devices 120A, 120B, respectively.

The service application 182, in one embodiment, may be adapted to utilize a selection processing module to process and monitor user selection events during online shopping by the user via the user devices 120A, 120B. In one aspect, the selection processing module allows the service provider 180 to process and monitor user selections during online navigation and shopping events over the network 160. For example, the service provider 180 interfaces with the user devices 120A, 120B via, e.g., a browser window to monitor the user and the user devices 120A, 120B during navigation and shopping events on various merchant sites. The selection processing module may be used by the service provider 180 to monitor user selections of one or more items, products, and/or services.

The service provider 180, in one embodiment, may be configured to maintain one or more user accounts (e.g., buyers, sellers, etc.) in an account database 190, each of which may include account information 192 associated with one or more individual users. In various examples, account information 192 may comprise user confidence data and information related to one or more users including a universal trust score. In other examples, account information 192 may include inventory information, such as types of items, products, and/or services proffered for sale by the user. As such, it should be appreciated that users may be considered a buyer or seller and proffer items, products, and/or services for sale over the network 160, without departing from the scope of the present disclosure.

In another example, account information 192 may include private financial data and information of user, such as one or more locations, addresses, account numbers, passwords, credit card information, banking information, or other types of financial information, which may be used to facilitate online financial transactions. In various implementations, the methods and systems described herein may be modified to accommodate additional users that may or may not be associated with at least one existing user account.

In one implementation, the users 102A, 102B and/or user devices 120A, 120B may have identity attributes stored with the service provider 180 as user identifiers 126A, 126B, respectively, and the users102A, 102B and/or user devices 120A, 120B may have credentials to authenticate or verify identity with the service provider 180. In one aspect, user attributes may include personal information and banking information, as previously described, including a universal trust score. In other aspects, the user attributes may be passed to the service provider 180 as part of a login and/or transaction request, and the user attributes may be utilized by the service provider 180 to associate the users 102A, 102B and/or the user devices 120A, 120B with one or more particular user accounts in the account database 190 maintained by the service provider 180.

The service provider 180, in various embodiments, may include a network interface component (NIC) 194 adapted for communication with the network 160 and any network based communication devices including the network interface components 128A, 128B of the user devices 120A, 120B. In various implementations, the network interface component 194 of the service provider 180 may include a wireless communication component, such as a wireless broadband component, a wireless satellite component, or various other types of wireless communication components including radio frequency (RF), microwave frequency (MWF), and/or infrared frequency (IRF) components adapted for communication with the network 160. In other various implementations, the network interface component 194 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The service provider 180, in one embodiment, may include one or more databases 196 (e.g., internal and/or external databases) for storing and tracking information related to financial transactions, including user confidence data and information, between one or more users and service provider 180. In one implementation, the databases 196 may provide a historical survey of financial transactions between the user devices 120A, 120B and the service provider 180. For example, the service interface application 182 may be adapted to monitor, track, log, and store transaction information, including user confidence data and information, related to network based electronic commerce between the user devices 120A, 120B and/or the service provider 180, and the stored transaction information is accessible from the databases 196 for assessment, analysis, maintenance, and settlement.

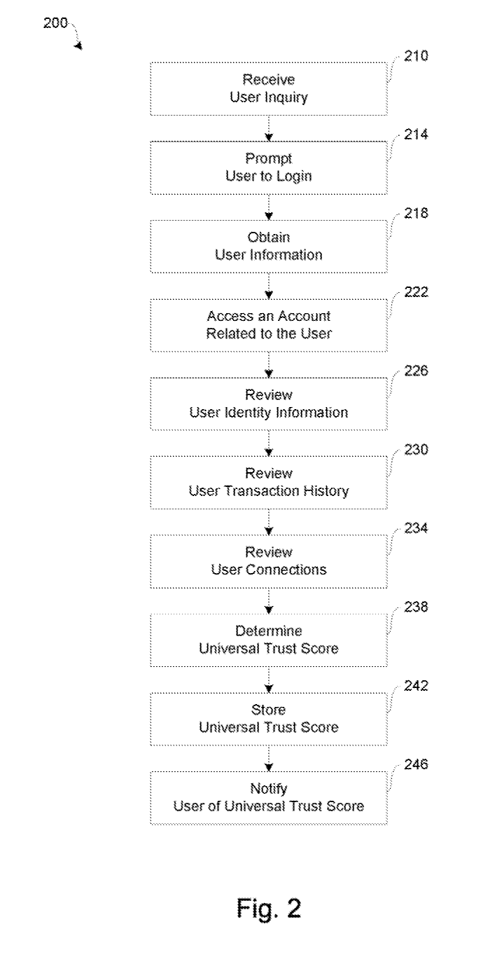

FIG. 2 shows one embodiment of a method 200 for facilitating electronic commerce including facilitating user confidence over a network 160. It should be appreciated that, for purposes of explanation, the method 200 of FIG. 2 is described in reference to the system 100 of FIG. 1, but should not be limited thereto.

Referring to FIG. 2, the service provider 180 is adapted to receive a user inquiry from at least one user 102A, 102B via at least one of the user devices 120A, 120B, respectively, over the network 160 (block 210). In one implementation, one of users 102A, 102B may visit an online website for the service provider 180 and request a universal trust score or other indication of reliability for a specific target user in order to aid the user in determining whether to proceed with a transaction with the target user. As such, in one aspect, upon user instruction, the service provider 180 may receive an inquiry or request from at least one of the user devices 120A, 120B over the network 160 in reference to a universal trust score related to the user or to a target user. Note that universal trust score does not have to be a numerical value, but can be any other form that indicates to the user a “trust” level of the target user. The user inquiry or user request may include user identity information related to the target user, which may be the same user making the request, including attributes related to the user, such as personal data and information related to the user (e.g., email address, usernames, passwords, account numbers, payment media information, photograph images, biometric ids, addresses including location information, phone numbers, etc.) and banking information related to the user (e.g., banking institutions, debit card issuers, credit card issuers, user account numbers, payment media information, security information, etc.).

In various implementations, the user may be considered a buyer, seller, merchant, etc., and the user may be inquiring about another user, buyer, seller, merchant, etc. without departing from the scope of the present disclosure. As such, in one aspect, the user may be inquiring or requesting a trust or confidence level for himself/herself, or in another aspect, the user may be inquiring or requesting a trust or confidence level for another user, such as another buyer, seller, merchant, etc. prior to conducting an online transaction.

The service provider 180 is adapted to prompt the user 102A, 102B to login from the user device 120A, 120B, respectively, over the network 160 (block 214), and the service provider 180 is adapted to obtain target user information, such as identity data and information, from the user inquiry or user request via the user devices 120A, 120B, respectively, over the network 160 (block 218). In one aspect, the user identity information may be utilized by the service provider 180 to verify the identity of the user.

The service provider 180 is adapted to access a user account related to the target user in the account database 190 based on user information passed from the user devices 120A, 120B over the network 160 (block 222) for target users having accounts with the service provider. If the target user does not have an account with the service provider, this step may be skipped. In one implementation, the service provider device 180 processes a user login request by attempting to locate, access, and verify an account related to the target user in the account database 190. If the target user is determined to be an existing user by the service provider 180, then the service provider 180 is adapted to locate, access, and verify the target user account and/or target user identity information provider by user 102 in the user login request by comparing the received target user information with account information 192 stored as part of the target user account in the account database 190. In one aspect, the service provider 180 may determine if the target user account is current and active.

It should be appreciated by those skilled in the art that the service provider 180 may cancel the user login request at any time during the process of method 200 if, for example, it is determined by the service provider 180 that the user enters wrong information or the user is trying to access an account with criminal intent.

In one implementation, once the target user account is accessed, the service provider 180 is adapted to review identity information related to the target user and/or target user account in the account database 190 (block 226). In one example, reviewing user identity information may include verifying one or more email addresses related to the target user and/or target user account. In another example, reviewing user identity information may include determining if the target user belongs to an online marketplace with an established global network of known users, buyers, sellers, merchants, etc., wherein purchasing and spending patterns of these known users, buyers, sellers, merchants, etc. may be utilized to identify a degree and/or value of trustworthiness and/or confidence of the target user. Location of the target user may also be a factor, such as whether the target user is in the same city as the user or whether the target user identity information is for another country.

Once the user account is accessed, the service provider 180 is adapted to review user transaction history related to the target user and/or target user account in the account database 190 (block 230). In one example, reviewing user transaction history may include reviewing credit card transactions related to the target user, wherein submission of a credit card by the target user provides a secure promise for payment. In another example, reviewing target user transaction history may include reviewing customer feedback scores and comments related to the target user that may reliably indicate a certain degree of trustworthiness of the target user. Success or failure of similar transactions by the target user may also be reviewed/evaluated. Target user transaction history can also be obtained from outside third party sources, such as through information available through the Internet, merchants, credit agencies, etc.

The service provider 180 may also be adapted to review user connections related to the target user and/or target user account in the account database 190 (block 234). In one implementation, reviewing user connections may include augmenting confirmed identity information with additional sources. For example, reviewing user connections in view of other sources may include pulling data from online navigation sites to confirm that an email is positively connected to the target user's name and/or the target user's address (e.g., a target user with a particular email address is truly a person living at a confirmed residential address). In another example, reviewing user connections in view of other sources may include tapping into social network sites, such as LinkedIn and Facebook, to identify and/or determine a degree of trust for the target user, based on how and who the target user is connected to. In one aspect, a trust or confidence level may increase if known that the target user is truly legitimate, resides locally, has a real occupation and/or the target user is friends with other known users, buyers, sellers, merchants, etc. Also, being friends with professionals (such as through LinkedIn) may result in a higher trust score, as opposed to being connected with high school students.

Target user connections may also include evaluating who the target user is connected to and how. For example, if a target user is connected to known fraudsters, who are his friends, the trust score may be lowered. If the target user is connected to known fraudsters, but only through one or more connections, the trust score may be lowered, but not as much, depending on how remote the connection is. If the target user is connected with friends that have good credit, high trustworthiness, etc., the trust score may be raised. If the target user is connected directly with a certain person, connections for that certain person may also be evaluated. For example, the certain person may be closely connected or associated with fraudsters. If the target user is a college professor and is connected with groups of professors, the trust score may increase. If the target user is married to a person known to the user (either directly or through one or more people), the trust score may increase. These are just some examples, but the general idea is to use a target user's connections to others in order to provide a more informed trust score, where information (good or bad) about the others are known and used to create a “social” or “business” map of the target user. Note that the target information being reviewed may be obtained by the service provider through any number of ways, such as searching information about the target user from the Internet, databases, merchants, retailer sites, or information services.

Once various information about the target user is obtained, reviewed, and/or evaluated, the service provider 180 is adapted to determine a universal trust score for the target user based on this information (block 238). The trust score may be a single number or letter. It may also be divided out into separate “sub” scores for each area that contributes to the final score, such as identity, transactions, and connections. Even with different categories, different scores may exist. For example, within transactions, if the target user is being evaluated for a transaction on Craigslist, trust scores within transactions may have different components, such as score using the service provider, score using transactions on Craigslist, transactions using credit cards, etc. These may also have different weighting factors to emphasize or deemphasize importance. In various implementations, the system 100 and method 200 are adapted to facilitate user confidence over a network, wherein user confidence refers to a process of conveying an indication of the trust level of a target user to a requesting user. Establishing trust between users is mutually beneficial prior to conducting financial transactions. As such, the system 100 and method 200 are adapted to facilitate user confidence over the network 160 by identifying, determining, calculating, and/or providing a universal trust score or other type of indication for the user so that the user may be better equipped to decide whether to move forward with a transaction with the target user.

In one aspect, the universal trust score may comprise a combination of an absolute number based on a buyer's transactional history and a relative number based on how many and/or how strong a connection is between the buyer and seller. In another aspect, the universal trust score may be developed as a user identifier or look-up mechanism on an online website that refers to a verified identity of the user. As such, in various aspects, the universal trust score provides a certain degree of trust via confirmed identity information of known users, buyers, sellers, merchants, etc., such as confirmed email addresses, confirmed purchasing history, confirmed selling history, confirmed delivery addresses, confirmed payment reconciliation, etc.

The universal trust score is dynamic in that it may consider any and all recent changes to any of the information used. For example, if the target user recently completely a successful transaction, the score may be slightly increased from an earlier score. If a primary connection or friend of the target user has recently been identified as a fraudster, the target user's score may decrease from an earlier score. Thus, the service provider continually uses any new information about the target user to make the universal trust score as accurate as possible. The information used is both within the service provider (internal) and from outside sources (external).

Within the service provider, the universal trust score may be one or more numbers as discussed above. For example, a very trustworthy target user may have a score from 95-100. A fairly trustworthy target user may have a score from 90-94. A less trustworthy target user, but still trustworthy, may have a score from 85-89. A target user that is okay, but maybe should proceed with caution, may have a score ranging between 75-80. These are just examples, as any scoring system may be employed.

The service provider 180 is adapted to store the universal trust score determined for the user (block 242). In one implementation, the user's universal trust score along with other user information (e.g., attributes related to the user including user name, user account number, user location, payment media information, etc.) may be stored as part of the user account in the account database 190. In another implementation, the service provider 180 may utilize one or more other databases (e.g., internal and/or external databases 196) for storing data and information related to financial transactions. Databases utilized by the service provider 180 may provide a historical survey of financial transactions between the user devices 120A, 120B and the service provider 180. The service provider 180 may be adapted to monitor, track, log, and store transaction information, including a universal trust score, related to network based electronic commerce between the user devices 120A, 120B and/or the service provider 180. The stored transaction information is accessible from the databases 196 for assessment, analysis, maintenance, and settlement. Storing the score(s) and other information may allow the service provider to more quickly and accurately update a trust score with any new transaction, connection, or identify data.

The service provider 180 is adapted to notify the user of the user's universal trust score over the network 160 (block 246). An absolute score may be given to the user. In other embodiments, multiple scores may be given for different categories so that the user can be provided with more detailed information with which to make a decision on moving forward with the transaction. Other formats may also be used. For example, different colors and/or letters may be used to convey different levels of trustworthiness or a brief descriptor may be used, such as “He's trustworthy,” “Stay away from her,” “Proceed with caution.” A written notification may also be provided, where the service provider gives the user reasons for the score, such as the user has engaged in ten successful transactions on Craigslist over the last month and you know his employer through LinkedIn.

In various implementations, the service provider 180 is adapted to notify users of a target user's universal trust score in any suitable format prior to conducting a transaction with the target user, either over the network 160 or in person. The service provider 180 is adapted to notify or alert users with notifications or alerts (e.g., email message, text message, instant message, voice message, etc.) provided over the network 160. The users 102A, 102B may review one or more universal trust scores via notifications or alerts displayed on user devices 120A, 120B, respectively.

In one embodiment, if implemented on an online marketplace, a user may pay a fee (e.g., $1 to $5) to receive a trust score or other information about a target user, such as a confirmed email address, or the user may be paid a fee (e.g., $1) for every email address the user verifies. In one implementation, for every user or buyer that responds to another user or seller, the service provider 180 for the online marketplace may return a trust code or trust score to the seller that provides a degree of trust for the buyer and vice versa. For a particular email address provided by the buyer, the seller may be provided with an A for internet transaction, a B for matching to the physical location, and an unknown on the network, which may refer to a “good” chance of success with a listing. The seller may provide another email address for another buyer, and the service provider may return an “unknown” for internet transaction, an A for physical location, and an A for matching to the physical location because the buyer may be multiple nodes removed from the seller in a social network. In another implementation, a similar situation may be similarly applied to the buyer, where the buyer may test the seller before meeting with the seller for a purchase exchange. As such, users belonging to a service provider network may be linked to known social network sites to assist with authenticating a user's identity and/or determine a level of risk or fraud. In one aspect, social networks may provide information about types of other users associated with a particular user, which may include, for example, direct contacts that are known as trustworthy and/or direct contacts that are known fraudsters.

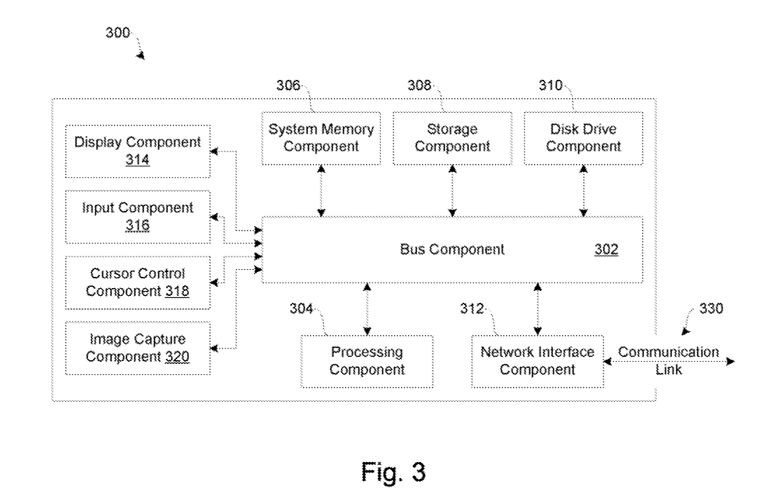

FIG. 3 is a block diagram of a computer system 300 suitable for implementing various embodiments of the present disclosure, including the user devices 120A, 120B and the service provider device 180. In various implementations, the user devices 120A, 120B may comprise a network communication device (e.g., mobile cellular phone, laptop, personal computer, etc.) capable of communicating with the network 160, and the service provider device 180 may comprise a network computing device (e.g., a network server). In other implementations, it should be appreciated that the service provider device 180 may comprise a network communication device (e.g., mobile cellular phone, laptop, personal computer, etc.) capable of communicating with the network 160, without departing from the scope of the present disclosure. Accordingly, it should be appreciated that each of the devices 120, 180 may be implemented as the computer system 300 for communication with the network 160 in a manner as follows.

In accordance with various embodiments of the present disclosure, computer system 300, such as a mobile communication device and/or a network server, includes a bus 302 or other communication mechanism for communicating information, which interconnects subsystems and components, such as processing component 304 (e.g., processor, micro-controller, digital signal processor (DSP), etc.), system memory component 306 (e.g., RAM), static storage component 308 (e.g., ROM), disk drive component 310 (e.g., magnetic or optical), network interface component 312 (e.g., modem or Ethernet card), display component 314 (e.g., CRT or LCD), input component 316 (e.g., keyboard), cursor control component 318 (e.g., mouse or trackball), and image capture component 320 (e.g., analog or digital camera). In one implementation, disk drive component 310 may comprise a database having one or more disk drive components.

In accordance with embodiments of the present disclosure, computer system 300 performs specific operations by processor 304 executing one or more sequences of one or more instructions contained in system memory component 306. Such instructions may be read into system memory component 306 from another computer readable medium, such as static storage component 308 or disk drive component 310. In other embodiments, hard-wired circuitry may be used in place of or in combination with software instructions to implement the present disclosure.

Logic may be encoded in a computer readable medium, which may refer to any medium that participates in providing instructions to processor 304 for execution. Such a medium may take many forms, including but not limited to, non-volatile media and volatile media. In various implementations, non-volatile media includes optical or magnetic disks, such as disk drive component 310, and volatile media includes dynamic memory, such as system memory component 306. In one aspect, data and information related to execution instructions may be transmitted to computer system 300 via a transmission media, such as in the form of acoustic or light waves, including those generated during radio wave and infrared data communications. In various implementations, transmission media may include coaxial cables, copper wire, and fiber optics, including wires that comprise bus 302.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 330 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 300 may transmit and receive messages, data, information and instructions, including one or more programs (i.e., application code) through communication link 330 and communication interface 312. Received program code may be executed by processor 304 as received and/or stored in disk drive component 310 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein showings therein are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for facilitating transactions over a network, the method comprising:
at a server, receiving an inquiry from a user via a user device over the network;
at the server, obtaining information related to a target user from the inquiry;
at the server, accessing a user account related to the target user based on information passed with the inquiry if the target user has an account with a service provider;
at the server, analyzing user transaction history of one or more previous transactions conducted between the target user and one or more other users;
at the server, analyzing user connections of the target user with others;
determining a trust score based on user information related to the user transaction history and the user connections; and
notifying the user of the trust score of the target user in a first format.

2. The method of claim 1, wherein the user connections comprise at least one of social connections or business connections.

3. The method of claim 1, further comprising, at the server, analyzing user identity information including verifying an email address of the target user, wherein the trust score is determined based on user identity information including the verified email address of the target user.

4. The method of claim 3, wherein analyzing user identity information includes determining if the target user belongs to an online marketplace with an established global network of known users, and wherein purchasing and spending patterns of these known users is utilized to identify a degree of trustworthiness of the target user.

5. The method of claim 1, wherein user transaction history includes information related to the target user stored as part of the user account, and wherein user transaction history includes a value or number associated with a rating of the target user.

6. The method of claim 1, wherein analyzing user transaction history includes analyzing credit card transaction history related to the target user.

7. The method of claim 1, wherein analyzing user transaction history includes analyzing customer feedback scores and comments related to the target user that indicates a degree of trustworthiness of the target user.

8. The method of claim 1, wherein user connections includes information related to the user stored as part of the user account, and wherein user connections includes a value or number associated with a rating of the target user.

9. The method of claim 1, wherein analyzing user connections includes analyzing information from online navigation sites to confirm that an email address of the target user is positively connected to at least one of a name of the target user and a residential address of the target user.

10. The method of claim 1, wherein analyzing user connections includes accessing social network sites to identify and determine a degree of trust that the target user is connected to other users.

11. The method of claim 1, wherein the trust score comprises a combination of an absolute number based on user transactional history and a relative number based on user connections with other users, and wherein the trust score provides a degree of trust via at least one of confirmed identity information, confirmed email address, confirmed purchasing history, confirmed selling history, confirmed delivery addresses, and confirmed payment reconciliation.

12. The method of claim 1, wherein notifying the user of the trust score comprises notifying the user via at least one of an email message, a text message, an instant message, and a voice message over the network.

13. The method of claim 1, wherein the method is performed by a network server adapted to communicate with the user device over the network.

14. The method of claim 1, wherein analyzing user connections comprises analyzing information about one or more of the others.

15. The method of claim 14, wherein the analyzing information comprises analyzing financial, personal, and/or social information about the one or more of the others.

16. The method of claim 1, further comprising updating the trust score based on a new transaction involving the target user.

17. The method of claim 1, wherein the first format is a single number or letter.

18. The method of claim 1, wherein the first format comprises a plurality of scores.

19. The method of claim 1, wherein the first format comprises a word description.

20. A non-transitory machine-readable medium comprising instructions, which when implemented by one or more processors perform the following operations:
receive an inquiry from a user via a user device;
obtain information related to a target user from the inquiry;
access, if possible, a user account related to the target user based on information passed with the inquiry;
analyze user transaction history conducted between the target user and one or more other users;
at the server, analyzing user connections of the target user with others;
determining a trust score based on user information related to the user transaction history and the user connections; and
notifying the user of the trust score of the target user in a first format.
